(19) United States
(12) Patent Application Publication
(10) Pub. No.: US 2025/0338276 A1
(43) Pub. Date: Oct. 30, 2025

(54) METHODS AND APPARATUSES OF UPLINK TRANSMISSION

(71) Applicant: LENOVO (BEIJING) LIMITED, Beijing (CN)

(72) Inventors: Chenxi ZHU, Fairfax, VA (US); Bingchao LIU, Beijing (CN); Yi ZHANG, Beijing (CN); Wei LING, Beijing (CN); Lingling XIAO, Beijing (CN)

(21) Appl. No.: 18/860,943

(22) PCT Filed: Apr. 29, 2022
(86) PCT No.: PCT/CN2022/090472

§ 371 Date: Oct. 28, 2024

(51) Int. Cl. H04W 72/21; H04L 27/26; H04W 72/1263

(52) U.S. Cl. CPC H04W 72/21; H04L 27/2636; H04L 27/2666; H04W 72/1263

(57) ABSTRACT

Embodiments of the present application are related to methods and apparatuses of uplink transmission. An embodiment of the present application provides a user equipment (UE) including: a transceiver; and a processor coupled to the transceiver, wherein the processor is configured to: receive, via the transceiver a medium access control (MAC) control element (CE) at least indicating a waveform for physical uplink shared channel (PUSCH) transmissions in an activated bandwidth part (BWP); and transmit, via the transceiver a PUSCH in the activated BWP with the waveform in the case that the waveform is applicable for the PUSCH.

### TECHNICAL FIELD

Embodiments of the present disclosure are related to wireless communication technology, and more particularly, related to methods and apparatuses of uplink (UL) transmission.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may transmit data signals to a base station (BS) via a physical uplink shared channel (PUSCH). Various waveforms, including a discrete Fourier transform-spread orthogonal frequency division multiplexing (DFT-s-OFDM) waveform and a cyclic prefix orthogonal frequency division multiplexing (CP-OFDM) waveform, may be applied to a PUSCH. Different waveforms may be advantageous in different scenarios. However, how to switch between different waveforms for different scenarios with low signal overhead and low delay needs to be solved.

### SUMMARY

Embodiments of the present disclosure at least provide a technical solution of switching a PUSCH waveform between different types, e.g., between CP-OFDM and DFT-s-OFDM via a medium access control (MAC) control element (CE).

According to some embodiments of the present disclosure, a UE may include: a transceiver; and a processor coupled to the transceiver, wherein the processor is configured to: receive, via the transceiver a MAC CE at least indicating a waveform for PUSCH in an activated bandwidth part (BWP); and transmit, via the transceiver a PUSCH in the activated BWP with the waveform in the case that the waveform is applicable for the PUSCH.

In some embodiments of the present disclosure, the waveform is DFT-s-OFDM or CP-OFDM.

In some embodiments of the present disclosure, the MAC CE indicates one or more waveforms to be applied for PUSCH in one or more BWPs of one or more cells, each waveform being signaled for individual BWP of each cell.

In some embodiments of the present disclosure, the MAC CE indicates one or more waveforms for PUSCH in one or more BWPs of one or more cells, each waveform being signaled for all BWPs of each cell.

In some embodiments of the present disclosure, whether the waveform is applicable for the PUSCH is determined based on scheduled time of a PUSCH by downlink control information (DCI) in a physical downlink control channel (PDCCH).

In some embodiments of the present disclosure, the waveform is applicable for the PUSCH in the case that the PUSCH is scheduled to be transmitted no earlier than a slot

$$( n + {kN}_{slot}^{subframe , μ} ) ,$$

wherein n is a slot where an acknowledgement (ACK) in response to the MAC-CE is sent, μ is subcarrier spacing (SCS) of a carrier where the ACK is sent, and k is a constant.

In some embodiments of the present disclosure, a length of the DCI is same for different waveforms for PUSCH, and each field of the DCI has a same size for different waveforms.

In some embodiments of the present disclosure, whether the waveform is applicable for the PUSCH is determined based on reception time of DCI in a PDCCH scheduling the PUSCH.

In some embodiments of the present disclosure, the waveform is applicable for the PUSCH in the case that the DCI is received no earlier than a slot

$$( n + {kN}_{slot}^{subframe , μ} ) ,$$

wherein, n is a slot where an ACK in response to the MAC-CE is sent, μ is SCS of a carrier where the ACK is sent, and k is a constant.

In some embodiments of the present disclosure, a length of the DCI is same or different for different waveforms used for PUSCH, and each field of the DCI has a same or a different size for different waveforms.

According to some embodiments of the present disclosure, a BS may include: a transceiver; and a processor coupled to the transceiver, wherein the processor is configured to: transmit, via the transceiver a MAC CE at least indicating a waveform for PUSCH in an activated BWP of a cell; and receive, via the transceiver a PUSCH in the activated BWP with the waveform in the case that the waveform is applicable for the PUSCH.

In some embodiments of the present disclosure, the waveform is DFT-s-OFDM or CP-OFDM.

In some embodiments of the present disclosure, the MAC CE indicates one or more waveforms for PUSCH in one or more BWPs of one or more cells, each waveform being signaled for individual BWP of each cell.

In some embodiments of the present disclosure, the MAC CE indicates one or more waveforms for PUSCH in one or more BWPs of one or more cells, each waveform being signaled for all BWPs of each cell.

In some embodiments of the present disclosure, whether the waveform is applicable for the PUSCH is determined based on scheduled time of reception of a PUSCH by DCI in a PDCCH.

In some embodiments of the present disclosure, the waveform is applicable for the PUSCH in the case that the PUSCH is scheduled to be transmitted no earlier than a slot

$$( n + {kN}_{slot}^{subframe , μ} ) ,$$

wherein n is a slot where an ACK in response to the MAC-CE is received, μ is SCS of a carrier where the ACK is sent, and k is a constant.

In some embodiments of the present disclosure, a length of the DCI is same for different waveforms for PUSCH, and each field of the DCI has a same size for different waveforms.

In some embodiments of the present disclosure, whether the waveform is applicable for the PUSCH is determined based on transmission time of DCI in a PDCCH scheduling the PUSCH.

In some embodiments of the present disclosure, the waveform is applicable for the PUSCH in the case that the DCI is received no earlier than a slot

$$( n + {kN}_{slot}^{subframe , μ} ) ,$$

wherein, n is a slot where an ACK in response to the MAC-CE is received, μ is SCS of a carrier where the ACK is sent, and k is a constant.

In some embodiments of the present disclosure, a length of the DCI is same or different for different waveforms used for PUSCH, and each field of the DCI has a same or a different size for different waveforms.

According to some other embodiments of the present disclosure, a method performed by a UE may include: receiving a MAC CE at least indicating a waveform for PUSCH in an activated BWP of a cell; and transmitting a PUSCH in the activated BWP with the waveform in the case that the waveform is applicable for the PUSCH.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates some fields of an exemplary MAC CE in Format 1 according to some embodiments of the present disclosure.

FIG. 2 illustrates some fields of an exemplary MAC CE in Format 2 according to some other embodiments of the present disclosure.

FIG. 3 is a flow chart illustrating an exemplary method performed by a UE for switching PUSCH waveform according to some embodiments of the present disclosure.

FIG. 4 illustrates an exemplary procedure of switching waveform according to some embodiments of the present disclosure.

FIG. 5 illustrates another exemplary procedure of switching waveform according to some embodiments of the present disclosure.

FIG. 6 is a flow chart illustrating exemplary method performed by a BS for switching PUSCH waveform according to some other embodiments of the present disclosure.

FIG. 7 illustrates a simplified block diagram of an exemplary apparatus of uplink transmission according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP LTE Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

According to some embodiments of the present disclosure, a UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE includes wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art. The UE may communicate with a BS via UL communication signals. A BS may be distributed over a geographic region. In certain embodiments of the present disclosure, the BS may also be referred to as an access point, an access terminal, a base, a base unit, a macro cell, a Node-B, an evolved Node B (eNB), a gNB, a Home Node-B, a relay node, or a device, or described using other terminology used in the art. The BS is generally a part of a radio access network that may include one or more controllers communicably coupled to one or more corresponding BSs. The BS may communicate with the UE via downlink (DL) communication signals.

The BS and the UE are within a wireless communication system (or a network) which may be compatible with any type of network that is capable of sending and receiving wireless communication signals. For example, the wireless communication system is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks. It is contemplated that there may be one or more UEs in the wireless communication system which are the same or similar to the aforementioned UE.

In some embodiments of the present disclosure, the wireless communication system is compatible with 5G NR of the 3GPP protocol. For example, the BS may transmit data using an OFDM modulation scheme on the DL and the UE may transmit data on the UL using a DFT-S-OFDM or CP-OFDM scheme. More generally, however, the wireless communication system may implement some other open or proprietary communication protocols, for example, WiMAX, among other protocols.

In some embodiments of the present disclosure, the BS and UE may communicate using other communication protocols, such as the IEEE 802.11 family of wireless communication protocols. Further, in some embodiments of the present disclosure, the BS and the UE may communicate over licensed spectrums, whereas in some other embodiments, the BS and UE may communicate over unlicensed spectrums. Embodiments of the present disclosure are not intended to be limited to the implementation of any particular wireless communication system architecture or protocol.

A UE may transmit data or messages to a BS via a PUSCH. A PUSCH may be one of: a dynamical PUSCH scheduled by a UL grant in a DCI, a PUSCH based on a configured grant (CG) such as CG Type 1 or CG Type 2 activated by a DCI; or a CG PUSSCH retransmission scheduled by the DCI, etc.

The CG Type 1 based PUSCH may refer to that: a PUSCH is semi-statically configured to operate in response to the reception of a higher layer parameter (e.g., the parameter configuredGrantConfig including rrc-ConfiguredUplinkGrant as specified in 3GPP standard documents) without the detection of a UL grant in a DCI. The CG Type 2 based PUSCH may refer to that: a PUSCH is semi-persistently scheduled by a UL grant in a valid activation DCI after the reception of a higher layer parameter (e.g., the parameter configuredGrantConfig not including rrc-ConfiguredUplinkGrant as specified in 3GPP standard documents).

There are various settings for a PUSCH mode. For example, the settings for the PUSCH mode include setting the waveform for the PUSCH. Various waveforms, including but not be limited to DFT-s-OFDM waveform and CP-OFDM waveform, are supported in a PUSCH(s) and may have their respective characteristics and corresponding advantages in different scenarios. For example, for a PUSCH with a DFT-s-OFDM waveform (e.g., the parameter transformPrecoder is enabled as specified in 3GPP standard), only one layer is supported; while for a PUSCH with a CP-OFDM waveform (e.g., the parameter transformPrecoder is disabled as specified in 3GPP standard documents), up to four layers can be supported. Moreover, compared with the CP-OFDM waveform, the peak to average power ratio (PAPR) of the DFT-s-OFDM waveform is lower, and the efficiency of the power amplifier in UE is higher. Therefore, when a UE is in different environments or scenarios, or when the UE performs different applications, the waveform of the PUSCH may be changed (or switched or updated) dynamically.

The PUSCH settings may be configured or changed by a PUSCH-Config message transmitted from a BS via RRC signaling, which is used to configure the UE specific PUSCH parameters applicable to a particular BWP. The BS may semi-statically configure or change a PUSCH mode by higher layer (e.g., a layer higher than a physical layer) signaling. e.g., radio resource control (RRC) signaling. The PUSCH-Config message contains a lot of settings, and each time the BS needs to change a part setting of the PUSCH (even though a single parameter), transmission of a new RRC message with complete PUSCH-Config from a BS to the UE is needed, which will cause large delay and large signaling overload. For example, in some cases, it spends 10 to 16 ms for the new waveform in the new PUSCH-Config becomes applicable after reception of the PUSCH-Config by the UE via a RRC signaling. This delay is long for a UE moving towards the cell edge or the cell center, and thus may cause service disruption.

A part of an exemplary PUSCH-Config of configuring the UE specific PUSCH parameters applicable to a particular BWP PUSCH is shown below.

PUSCH-Config information element

-- ASN1START
-- TAG-PUSCH-CONFIG-START

| PUSCH-Config ::= | SEQUENCE { | |
|---|---|---|
| dataScramblingIdentityPUSCH | INTEGER (0..1023) | OPTIONAL, -- Need S |
| txConfig | ENUMERATED {codebook, nonCodebook} | OPTIONAL, -- Need S |
| dmrs-UplinkForPUSCH-MappingTypeA | SetupRelease { DMRS-UplinkConfig } | OPTIONAL, -- Need M |
| dmrs-UplinkForPUSCH-MappingTypeB | SetupRelease { DMRS-UplinkConfig } | OPTIONAL, -- Need M |
| pusch-PowerControl | PUSCH-PowerControl | OPTIONAL, -- Need M |
| frequencyHopping | ENUMERATED {intraSlot, interSlot} | OPTIONAL, -- Need S |

| | |
|---|---|
| frequencyHoppingOffsetLists | SEQUENCE (SIZE (1..4)) OF INTEGER (1..maxNrofPhysicalResourceBlocks-1) |

OPTIONAL, -- Need M

| resourceAllocation | ENUMERATED { resourceAllocationType0, resourceAllocationType1, dynamicSwitch}, | |
|---|---|---|
| pusch-TimeDomainAllocationList | SetupRelease { PUSCH-TimeDomainResourceAllocationList } | OPTIONAL, -- Need M |
| pusch-AggregationFactor | ENUMERATED { n2, n4, n8 } | OPTIONAL, -- Need S |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| transformPrecoder | ENUMERATED {enabled, disabled} | OPTIONAL, -- Need S |

| | |
|---|---|
| codebookSubset | ENUMERATED {fullyAndPartialAndNonCoherent, partialAndNonCoherent,nonCoherent} |

...

| | OPTIONAL, -- Need M | |
|---|---|---|
| invalidSymbolPatternIndicatorDCI-0-1-r16 | ENUMERATED {enabled} | OPTIONAL, -- Need S |
| priorityIndicatorDCI-0-1-r16 | ENUMERATED {enabled} | OPTIONAL, -- Need S |
| pusch-RepTypeIndicatorDCI-0-1-r16 | ENUMERATED { pusch-RepTypeA, pusch-RepTypeB} | OPTIONAL, -- Need R |
| frequencyHoppingDCI-0-1-r16 | ENUMERATED {interRepetition, interSlot} | OPTIONAL, -- Cond RepTypeB |
| uci-OnPUSCH-ListDCI-0-1-r16 | SetupRelease { UCI-OnPUSCH-ListDCI-0-1-r16 } | OPTIONAL, -- Need M |

-- End of the parameters for DCI format 0_1 introduced in V16.1.0

| invalidSymbolPattern-r16 | InvalidSymbolPattern-r16 | OPTIONAL, -- Need S |
|---|---|---|
| pusch-PowerControl-v1610 | SetupRelease {PUSCH-PowerControl-v1610} | OPTIONAL, -- Need M |
| ul-FullPowerTransmission-r16 | ENUMERATED {fullpower, fullpowerMode1, fullpowerMode2} | OPTIONAL, -- Need R |
| pusch-TimeDomainAllocationListForMultiPUSCH-16 | SetupRelease { PUSCH-TimeDomainResourceAllocationList-r16 } | |
| | OPTIONAL, -- Need M | |
| numberOfInvalidSymbolsForDL-UL-Switching-r16 | INTEGER (1..4) | OPTIONAL -- Cond RepTypeB2 |

]]
}

In the exemplary PUSCH-Config, a parameter (item) named transformPrecoder is for setting the waveform of PUSCH. If transformPrecoder is set to 1 (i.e., being enabled), DFT-s-OFDM waveform is used for PUSCH; and if transformPrecoder is set to 0 (i.e., being disabled), CP-OFDM waveform is used for PUSCH. When the BS decides to change the waveform of the PUSCH due to e.g., UE movement from a cell edge to a cell center or from the cell center to the cell edge, the BS will transmit a PSCH-Config with a new value of transformPrecoder via RRC signaling.

Furthermore, it is time-consuming to reconfigure the waveform using an RRC message each time. The latency of RRC reconfiguration may not support the dynamic switching required in the case, for example, when the UE keeps moving between the cell edge and the cell center.

Embodiments of the present disclosure provide a solution of switching waveforms via a MAC CE message instead of the PUSCH-Config. For example, some embodiments of the present disclosure design a mechanism of signaling switching dynamically PUSCH waveform between different waveforms, e.g., DFT-S-OFDM and CP-OFDM, etc., using a MAC CE message, so as to reduce the application time of the signaled waveform from the BS or the network.

Specifically, for a cell, which has one or more BWPs, none, or partial or all of the BWP(s) in the cell may need to switch waveform for PUSCH. One cell may be a serving cell for a UE, and one BWP of the serving cell may be an activated BWP. A MAC CE can indicate the waveform switched for PUSCH, e.g., scheduled PUSCH or activated PUSCH in various manners.

For example, in some embodiments of the present disclosure, the MAC CE only indicates the BWPs where the waveforms for PUSCH need to be changed or updated and the waveforms that to be applied on these BWPs. While, in some other embodiments, the MAC CE indicates all the BWP(s) and the corresponding waveforms for PUSCH on all the indicated BWP(s) regardless whether they need waveform switching or not. If an indicated waveform is the same as the current waveform being applied on an indicated BWP, the current waveform will be continued being applied for PUSCH on the indicated BWP.

In some embodiments of the present application, the MAC CE indicates one or more waveforms to be applied for PUSCH in one or more BWPs of one or more cells, each waveform being signaled for individual BWP of each cell (Format 1). While, in some other embodiments of the present application, the MAC CE indicates one or more waveforms for PUSCH in one or more BWPs of one or more cells, each waveform being signaled for all BWPs of each cell (Format 2).

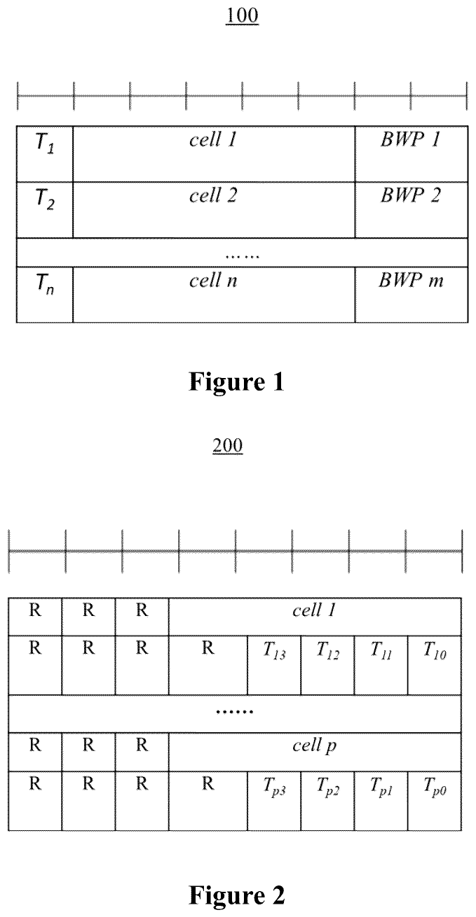

FIG. 1 illustrates some fields of an exemplary MAC CE 100 in Format 1 according to some embodiments of the present disclosure.

Referring to FIG. 1, there are n field(s) in the MACE CE for waveform switching. For each filed, one bit, e.g., Tₙ is used to indicate the waveform for each BWP (e.g., by indicating the transformPrecoder state), 5 bits are used to indicate cell, e.g., identifier of each cell where the BWP is, and two bits are used to indicate the BWP of the cell, e.g., identifier of a corresponding BWP of the cell. Persons skilled in the art should well know that the specific bit number illustrated herein is only for illustrating the format of the MAC CE, and should not be deemed as the limitation to the scope of the present disclosure. In the exemplary MAC CE, only one BWP in each cell is shown. However, in some other embodiments of the present application, waveforms of more than one BWP in the same cell will be changed, and there will be a plurality of identical cell IDs while different BWP IDs in the MAC CE.

Tₙ indicated in the MAC CE 100 may be set to 0 or 1, which signals the transformPrecoder status (disabled or enabled) for a BWP of a cell n. If Tₙ, which corresponds to BWP m of cell n, is set to 1, waveform DFT-s-OFDM for PUSCH will be applied to BWP m of cell n; and if Tₙ, which corresponds to BWP m of cell n is set to 0, waveform CP-OFDM will be applied to BWP m of cell n, vice versa. In some embodiments, BWP m corresponding to waveform Tₙ is an activated BWP of a serving cell for a UE.

FIG. 2 illustrates another exemplary MAC CE 200 in Format 2 according to some other embodiments of the present disclosure.

Referring to FIG. 2, the MAC CE 200 indicates one or more BWPs of each cell, and the indication of waveforms, e.g., indicated by T₁₀, T₁₁, T₁₂, T₁₃ . . . Tₚ₀, Tₚ₁, Tₚ₂, Tₚ₃ (e.g., indicating the transformPrecoder state for a BWP of a cell) corresponding to the one or more BWPs in each cell. In the MAC CE, it is supposed that one cell supports up to 4 BWPs, and accordingly, for each cell, there are 4 waveforms indicated in the MAC CE 200, each corresponding to a corresponding BWP of the cell. For example, Tₚ₀ indicates the waveform for the first BWP of cell p, Tₚ₁ indicates the waveform for the first BWP of cell p, Tₚ₂ indicates the waveform for the first BWP of cell p, and, Tₚ₃ indicates the waveform for the first BWP of cell p. A waveform, e.g., Tₚ₂ indicated in the MAC CE 200 may be set to 0 or 1. If Tₚ₂ is set to 1 (e.g., transformPrecoder is “enabled”), waveform DFT-s-OFDM for PUSCH will be applied in BWP 2 of cell p; and if Tₚ₂ is set to 0 (e.g., transformPrecoder is “disabled”), waveform CP-OFDM will be applied on BWP p of cell p. Similarly, it is contemplated that a cell may support a different number of BWPs, e.g., more than 4 BWPs, and thus the illustrated specific number should not be used as the limitation to the scope of the present disclosure.

When a waveform, e.g., Tₙ indicated in MAC CE100 or Tₚ₂ indicated in the MAC CE 200 indicates the same waveform as currently used for PUSCH in a corresponding BWP in a corresponding cell, the current used waveform will be used in PUSCH in the corresponding BWP in the corresponding cell. If a waveform, e.g., e.g., Tₙ indicated in MAC CE100 or Tₚ₂ indicated in the MAC CE 200 indicates a different waveform from the currently used waveform in a corresponding BWP, the waveform will be used for PUSCH in the corresponding BWP

For example, if Tₚ₂ is 1, and the currently used waveform for PUSCH in BWP 2 of cell p is DFT-s-OFDM, then DFT-s-OFDM is continued being used for PUSCH on BWP 2 of cell p. If Tₚ₂ is 1, and the currently used waveform for PUSCH in BWP 2 of cell p is CP-OFDM, then DFT-s-OFDM will be applied for PUSCH on BWP 2 of cell p and the waveform is switched.

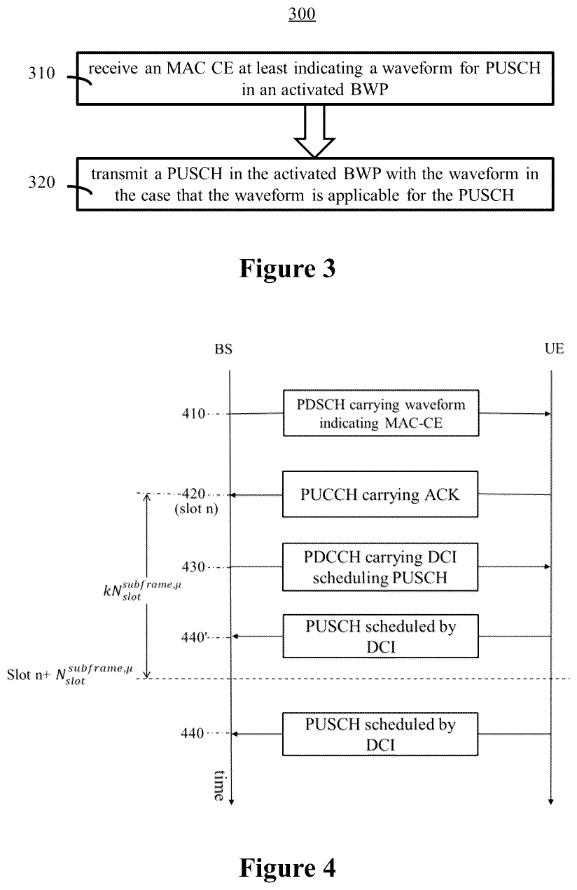

FIG. 3 is a flow chart illustrating an exemplary method performed by a UE for switching PUSCH waveform according to some embodiments of the present disclosure. MAC CE, e.g., the MAC CE 100 or the MAC CE 200 as illustrated above will be used for waveform switching.

As shown in FIG. 3, the method 300 includes two operations: operation 310 and operation 320. In operation 310, the UE receives a MAC CE (e.g., the MAC CE 100 or the MAC CE 200) at least indicating a waveform for PUSCH in an activated BWP. In operation 420, the UE transmits a PUSCH in the activated BWP with the indicated waveform in the case that the waveform is applicable for the PUSCH.

In some embodiments of the present disclosure, the UE may receive more than one MAC CE for configuring waveform(s) for PUSCH in at least one BWP in at least one cell, and each MAC CE may have the same format as that illustrated above.

Upon receiving the waveform signaling MAC-CE, UE needs to prepare for transmitting the PUSCH in the signaled waveform. When the waveform is the same as the currently used waveform in the activated BWP, the waveform is continued to be used for PUSCH in the activated BWP. The application time of the indicated waveform does not affect the PUSCH transmission. However, mostly, the indicated waveform is different, and the indicated waveform is to be used after a duration for PUSCH in the activated BWP. Thus, an unambiguous understanding of the time when the first PUSCH with the waveform indicated in the MAC CE will be transmitted is needed for both UE and network. In other words, both the network side, e.g., a BS and the UE need to determine when the waveform is applicable. Only the waveform is applicable for PUSCH transmission in an activated BWP of the UE, the BS and UE will apply the waveform for PUSCH in the activated BWP.

According to some embodiments, whether or when the waveform indicated in the received MAC CE for the activated BWP is applicable depends upon the time when the PUSCH is transmitted, e.g., scheduled time of PUSCH. The UE will transmit PUSCH in the activated BWP with the waveform indicated in the MAC CE after a duration from the transmission of the ACK to the BS in response to the reception of the MAC CE. In other words, if the PUSCH is transmitted after the duration, the waveform indicate in the MAC CE will be applied for the PUSCH in the activated BWP; otherwise, the waveform indicated in the MAC CE will not be applied for the PUSCH in the activated BWP before being applicable.

In some embodiments, the duration is

$${kN}_{slot}^{subframe , μ} ;$$

wherein, μ is SCS of a carrier where the ACK in response to the reception of the MAC CE is sent to the BS, k is a constant, for example, 3. In some embodiments, k is signaled to the BS or the network by the UE as part of its capability.

For example, if the PUCCH carrying the ACK is transmitted by the UE in slot n (of the PUCCH subcarrier), the waveform indicated in the MAC CE is applicable for PUSCH no earlier than a slot

$$( n + {kN}_{slot}^{subframe , μ} ) .$$

For a PUSCH scheduled by a DCI (DCI in a PDCCH), the time when the PUSCH is transmitted is determined by the DCI (e.g., the time domain resource assignment field within the DCI). In other words, whether the waveform indicated in the MAC CE is applicable for the scheduled PUSCH in the activated BWP is determined based on the scheduled time of the PUSCH determined by the DCI.

FIG. 4 illustrates an exemplary procedure of switching PUSCH waveform according to some embodiments of the present disclosure.

Referring to FIG. 4, the UE receives a MAC CE in time 410 from the BS which indicates at least a waveform for PUSCH in an activated BWP. After successfully receiving the MAC CE, the UE transmits an ACK in a PUCCH in time 420 (e.g., slot n) in response to the reception of the PDSCH as an acknowledgement which indicates that the UE has received the MAC CE successfully. Then the waveform indicated in the MAC CE for the PUSCH in the activated BWP will be applicable no earlier than slot

$$( n + {kN}_{slot}^{subframe , μ} ) .$$

Before the slot

$$( n + {kN}_{slot}^{subframe , μ} ) ,$$

the UE still use a currently waveform configured for PUSCH in the activated BWP.

The UE may receive a DCI scheduling a transmission of a PUSCH in the activated BWP in time 430. If the PUSCH is scheduled to be transmitted in the activated BWP before slot

$$( n + {kN}_{slot}^{subframe , μ} ) ,$$

e.g., in time 440′, the waveform indicated in the MAC CE is not applied. If the PUSCH is scheduled to be transmitted in the activated BWP no earlier than slot

$$( n + {kN}_{slot}^{subframe , μ} ) ,$$

e.g., in time 440, the waveform indicated in the MAC CE will be applied for the PUSCH scheduled by the DCI.

When the UE receives a DCI scheduling a PUSCH to be transmitted in the activated BWP, it will first decode and recover the DCI. However, the DCI format (e.g., DCI format 0_1, DCI format 0_2) of the DCI is associated with the waveform of the scheduled PUSCH, and before decoding and recovering the DCI, the UE cannot determine when to transmit the PUSCH and thus cannot determine which waveform is to be applied for the PUSCH. That is, the UE has to blindly decode and recover the DCI, and thus problems may rise.

For example, the DCI format 0_1 or DCI format 0_2 scheduling PUSCH is different for different waveforms, including the total size of the DCI and bit widths of some fields within the DCI. For example, bitfield transformPrecoder in DFT-s-OFDM is set to disabled, while bitfield transformPrecoder in CP-OFDM is set to enabled. Furthermore, some bitfields in the DCI may have different bit widths for different waveforms based on different configurations for different scenarios. These bitfields in the DCI may require different interpretations for different waveforms of the scheduled PUSCH. However, when a UE tries to decode the DCI, it does not know the time when the PUSCH is scheduled to be transmitted and thus cannot determine which waveform will be applied for transmitting the PUSCH. Thus, it brings problems for the UE to determine the bit widths of some fields and how to interpret these bitfields in the DCI.

To solve these problems, the present disclosure provides a DCI bitfield format which is applicable for different waveforms.

In an exemplary DCI, the size (or length) of DCI is identical for different waveforms, and each bitfield in the DCI is the same for different waveforms. Therefore, there is no ambiguity no matter which waveform will be applied for the scheduled PUSCH. In some other embodiments, for each bitfield, the size is the maximum size of corresponding bitfields for different waveforms (e.g., CP-OFDM and DFT-s-OFDM).

Furthermore, in some embodiments, the DCI bitfield format provided by the present disclosure has no field signaling the waveform, because the waveform of the scheduled PUSCH is determined based on its scheduled transmission time that is determined by the time domain resource assignment field within the DCI.

Therefore, according to the DCI format provided by the present disclosure, even if the UE cannot know the scheduled time of the PUSCH and cannot determine which waveform is to be applied for the PUSCH, the UE can also decode the DCI and recover the DCI correctly.

According to some embodiments, for a PUSCH scheduled by a DCI, whether the waveform indicated in the received MAC CE is applicable depends upon the time when the DCI is received. The UE will transmit PUSCH in the activated BWP with the waveform indicated in the MAC CE if the DCI scheduling the PUSCH is received after a duration from the transmission of the ACK to the BS in response to the reception of the MAC CE. In some embodiments, the duration is

$${kN}_{slot}^{subframe , μ} ;$$

wherein, μ is SCS of a carrier where the ACK is sent, k is a constant, for example, 3. k can be signaled to the BS or the network by the UE as part of its capability in some embodiments of the present disclosure.

Since the waveform of the scheduled PUSCH depends upon the reception time of the DCI scheduling the PUSCH, the UE knows the waveform of the PUSCH before it decodes and recovers the received DCI. Thus, the UE has no special requirements on the DCI format. That is, the DCI may be a legacy DCI or an aforementioned novel DCI with new bitfield format provided by the present disclosure. In other words, a length of the DCI may be the same or different for different waveforms used for PUSCH, and each bitfield of the DCI may have the same or a different size for different waveforms.

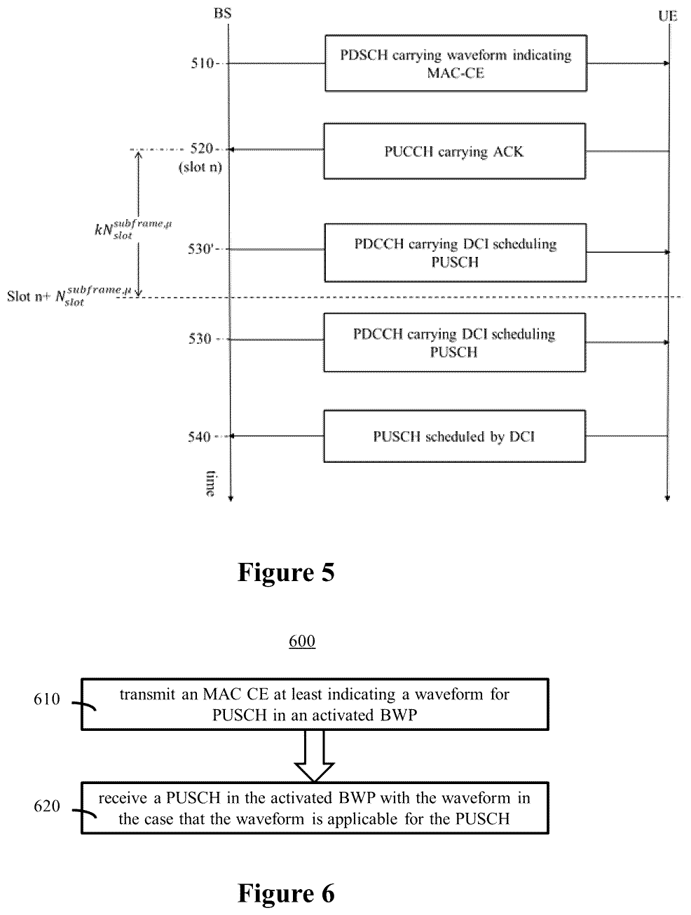

FIG. 5 illustrates an exemplary procedure according to some embodiments of the present disclosure.

Referring to FIG. 5, the UE receives a MAC CE in time 510 from the BS which indicates at least a waveform for PUSCH in an activated BWP. After successfully receiving the MAC CE, the UE transmits an ACK in a PUCCH corresponding to the PDSCH in time 520 (i.e. slot n) as an acknowledgement which indicates that the UE has received the MAC CE successfully. Then, the BS transmits a DCI scheduling a PUSCH to be transmitted in the active BWP. If the DCI is received earlier than the slot

$$( n + {kN}_{slot}^{subframe , μ} ) ,$$

e.g., in time 530′, the UE will transmit the PUSCH in the activated BWP with the current waveform, e.g., previously configured by RRC. If the DCI is received no earlier than the slot

$$( n + {kN}_{slot}^{subframe , μ} ) ,$$

e.g., in time 530, the UE will transmit the PUSCH in the activated BWP with the waveform indicated in the MAC CE, e.g., in time 540.

FIG. 6 is a flow chart illustrating an exemplary method 600 of uplink transmission according to some embodiments of the present disclosure, which may be performed in the network side, e.g., by a gNB. A MAC CE, e.g., the MAC CE 100 or the MAC CE 200 provided by the present disclosure will be used for switching waveform for PUSCH.

As shown in FIG. 6, the method 600 includes two operations: operation 610 and operation 620. In operation 610, the BS transmits a MAC CE e.g., the MAC CE 100 or the MAC CE 200 at least indicating a waveform for PUSCH in an activated BWP. In operation 620, the BS receives a PUSCH in the activated BWP with the waveform in the case that the waveform is applicable for the PUSCH.

It is contemplated that the BS performs corresponding methods consistent with the UE according to some embodiments of the present disclosure.

For example, the BS may transmit one or more MAC CE for configuring waveform(s) for PUSCH reception(s) in at least one BWP in at least one cell. The MAC CE indicates one or more waveforms for PUSCH in one or more BWPs of one or more cells, each waveform being signaled for individual BWP of each cell, or for all BWPs of each cell.

In some embodiments, whether the waveform is applicable for the PUSCH in the UE is determined based on scheduled time of reception of a PUSCH by DCI in a PDCCH. For example, the waveform is applicable for the PUSCH in the case that the PUSCH is scheduled to be transmitted no earlier than a slot

$$( n + {kN}_{slot}^{subframe , μ} ) ,$$

wherein n is a slot where an ACK in response to the MAC-CE is received, μ is SCS of a carrier where the ACK is sent, and k is a constant, e.g., 3. To achieve unambiguous determination in the network side and UE, the length of the DCI is the same for different waveforms for PUSCH, and each field of the DCI has a same size for different waveforms.

In some other embodiments, whether the waveform is applicable for the PUSCH is determined based on transmission time of DCI in a PDCCH scheduling the PUSCH. For example, the waveform is applicable for the PUSCH in the case that the DCI is received no earlier than a slot

$$( n + {kN}_{slot}^{subframe , μ} ) .$$

The length of the DCI is the same or different for different waveforms used for PUSCH, and each field of the DCI has a same or a different size for different waveforms.

Given the above, a new mechanism to signal the UL waveform for PUSCH and new MAC CE designs are provided, which can reduce the waveform change delay, reduce the signalling overhead, and thus improve the user experience and system performance.

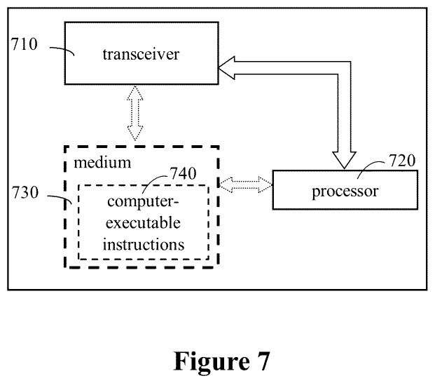

FIG. 7 illustrates a simplified block diagram of an exemplary apparatus according to some embodiments of the present disclosure.

In some embodiments, the apparatus 700 may be or include at least part of a UE which is capable of performing at least method 300 or any other methods mentioned above, which relates to a MAC CE (e.g., the MAC CE 100, the MAC CE 200) for configuring waveform(s) for PUSCH.

In some other embodiments, the apparatus 700 may be or include at least part of a BS which is capable of perform at least method 700 or any other methods mentioned above, which relates to a MAC CE (e.g., the MAC CE 100, the MAC CE 200) for configuring waveform(s) for PUSCH.

As shown in FIG. 7, the apparatus 700 may include at least transceiver 710 and processor 720, wherein transceiver 710 may be coupled to processor 720. Furthermore, the apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, transceiver 710, non-transitory computer-readable medium 730, and processor 720 may be coupled to each other via one or more local buses.

Although in FIG. 7, elements such as transceiver 710, non-transitory computer-readable medium 730, and processor 720 are described in the singular, the plural is contemplated unless limitation to the singular is explicitly stated. In certain embodiments of the present disclosure, the apparatus 700 may further include other components for actual usage.

In various example embodiments, processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 720 may also include at least one other circuitry or element not shown in FIG. 7.

In various example embodiments, non-transitory computer-readable medium 830 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 830 may include, but is not limited to, an electric, a magnetic, an optical, an electromagnetic, an infrared, or a semiconductor system, apparatus, or device or any combination of the above.

Further, in various example embodiments, exemplary apparatus 800 may also include at least one other circuitry, element, and interface, for example antenna element, and the like.

In various example embodiments, the circuitry, parts, elements, and interfaces in exemplary apparatus 800, including processor 820 and non-transitory computer-readable medium 830, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive a medium access control (MAC) control element (CE) indicating a waveform for physical uplink shared channel (PUSCH) in an activated bandwidth part (BWP); and
transmit a PUSCH in the activated BWP with the waveform when the waveform is applicable for the PUSCH.

2. The UE of claim 1, wherein the waveform is a discrete Fourier transform-spread orthogonal frequency division multiplexing (DFT-s-OFDM) or a cyclic prefix orthogonal frequency division multiplexing (CP-OFDM).

3. The UE of claim 1, wherein the MAC CE indicates:
one or more waveforms to be applied for PUSCH in one or more BWPs of one or more cells, wherein each waveform is signaled for individual BWP of each cell.

4. The UE of claim 1, wherein the MAC CE indicates:
one or more waveforms for PUSCH in one or more BWPs of one or more cells, wherein each waveform is signaled for all BWPs of each cell.

5. The UE of claim 1, wherein the waveform is applicable for the PUSCH based on scheduled time of a PUSCH by downlink control information (DCI) in a physical downlink control channel (PDCCH).

6. The UE of claim 5, wherein the waveform is applicable for the PUSCH when the PUSCH is scheduled to be transmitted no earlier than a slot
$$( n + {kN}_{slot}^{subframe , μ} ) ,$$
wherein n is a slot where an acknowledgement (ACK) in response to the MAC-CE is sent, μ is subcarrier spacing (SCS) of a carrier where the ACK is sent, and k is a constant.

7. The UE of claim 5, wherein a length of the DCI is same for different waveforms for PUSCH, and each field of the DCI has a same size for different waveforms.

8. The UE of claim 1, wherein the waveform is applicable for the PUSCH based on reception time of downlink control information (DCI) in a physical downlink control channel (PDCCH) scheduling the PUSCH.

9. The UE of claim 8, wherein the waveform is applicable for the PUSCH when the DCI is received no earlier than a slot
$$( n + {kN}_{slot}^{subframe , μ} ) ,$$
wherein, n is a slot where an acknowledgement (ACK) in response to the MAC-CE is sent, μ is subcarrier spacing (SCS) of a carrier where the ACK is sent, and k is a constant.

10. The UE of claim 8, wherein a length of the DCI is same or different for different waveforms used for PUSCH, and each field of the DCI has a same or a different size for different waveforms.

11. A base station (BS) for wireless communication, comprising:
at least one memory; and
at least one processor coupled with the at least one memory and configured to cause the BS to:
transmit a medium access control (MAC) control element (CE) indicating a waveform for physical uplink shared channel (PUSCH) in an activated bandwidth part (BWP) of a cell; and
receive a PUSCH in the activated BWP with the waveform when the waveform is applicable for the PUSCH.

12. The BS of claim 11, wherein the waveform is a discrete Fourier transform-spread orthogonal frequency division multiplexing (DFT-s-OFDM) or a cyclic prefix orthogonal frequency division multiplexing (CP-OFDM).

13. The BS of claim 11, wherein the MAC CE indicates:
one or more waveforms for PUSCH in one or more BWPs of one or more cells, wherein each waveform being signaled for individual BWP of each cell.

14. The BS of claim 11, wherein, the MAC CE indicates:
one or more waveforms for PUSCH in one or more BWPs of one or more cells, each waveform being signaled for all BWPs of each cell.

15. A method performed by a user equipment (UE), comprising:
receiving a medium access control (MAC) control element (CE) indicating a waveform for physical uplink shared channel (PUSCH) in an activated bandwidth part (BWP) of a cell; and
transmitting a PUSCH in the activated BWP with the waveform when the waveform is applicable for the PUSCH.

16. The method of claim 15, wherein the waveform is a discrete Fourier transform-spread orthogonal frequency division multiplexing (DFT-s-OFDM) or a cyclic prefix orthogonal frequency division multiplexing (CP-OFDM).

17. The method of claim 15, wherein the MAC CE indicates:
one or more waveforms to be applied for PUSCH in one or more BWPs of one or more cells, wherein each waveform is signaled for individual BWP of each cell.

18. A processor for wireless communication, comprising:
at least one controller coupled with the at least one memory and configured to cause the processor to:
receive a medium access control (MAC) control element (CE) indicating a waveform for physical uplink shared channel (PUSCH) in an activated bandwidth part (BWP); and
transmit a PUSCH in the activated BWP with the waveform when the waveform is applicable for the PUSCH.

19. The processor of claim 18, wherein the waveform is a discrete Fourier transform-spread orthogonal frequency division multiplexing (DFT-s-OFDM) or a cyclic prefix orthogonal frequency division multiplexing (CP-OFDM).

20. The processor of claim 18, wherein the MAC CE indicates:
one or more waveforms to be applied for PUSCH in one or more BWPs of one or more cells, wherein each waveform is signaled for individual BWP of each cell.
